(19) United States
(12) Patent Application Publication
(10) Pub. No.: US 2017/0290292 A1
(43) Pub. Date: Oct. 12, 2017

(54) COATINGS FOR DAG PREVENTION

(71) Applicant: Empire Technology Development LLC, Wilmington, DE (US)

(72) Inventor: Kock-Yee Law, Penfield, NY (US)

(21) Appl. No.: 15/094,509

(22) Filed: Apr. 8, 2016

(51) Int. Cl. A01K 13/00; C11D 9/00; C11D 17/00

(52) U.S. Cl. CPC A01K 13/006; A01K 13/002; A01K 13/001; C11D 17/0065; C11D 9/007; C11D 9/002

(57) ABSTRACT

Techniques are disclosed for preventing formation of dags on cattle and other commercially produced animals. The surface of the animal, such as the skin, hide, hair, wool or other covering of the animal, is treated with a low-energy, non-sticking hydrophobic coating. The coating may be made from long-chain hydrocarbons, such as stearates, typically with a terminal metal carboxylate group comprising a variety of low-valence metals, e.g., mono or divalent metals, such as calcium, magnesium, potassium, sodium and zinc. The coating makes it difficult for polar substances, such as water, mud, dirt, waste, soil, manure and feed, collectively termed dag, to adhere to the surface of the animal.

### TECHNICAL FIELD

The disclosure relates generally to management and care of animals and livestock, and more particularly to the mitigation of dag on the surface of animals and livestock.

### BACKGROUND

Foreign matter may accumulate on the surface of cattle and other livestock while being cared for at a livestock producer or at a feedlot. By the term surface is meant the skin, hide, hair, wool or other covering of an animal. The foreign matter may include clumps of soil, manure, feed and the like. The foreign matter tends to form dags on the surface of the animals. A dag is a lock of matter or dung-coated hair or wool. For this disclosure, a dag is considered to be any foreign matter that clings to the surface of an animal.

Dags are a significant problem, for example, in the beef processing industry, especially during the rainy season. Cattle with dag need to be cleaned, which can cause stress to the animal and result in poor meat quality. Cleaning also adds additional processing time and cost to beef processing. Daggy cattle have a high potential for a contaminated carcass, which may present a hygiene problem during beef processing.

The problem is not limited to commercially-produced livestock, such as beef, swine, sheep, lambs, and so forth. Household pets, especially those in rural areas or animals used in recreational pursuits, such as hunting dogs and tracking dogs, and service animals such as those used in police and combat service, also face rain, water and foreign matter that may result in dag formation. These animals may be comfortable and perform better if they are dag-free during service. Cleaning them may also be easier if dag formation is prevented.

Unless otherwise indicated herein, the materials described in this section are not prior art to the claims in this application and are not admitted to be prior art by inclusion in this section.

### SUMMARY

Technologies are herein disclosed for preventing formation of dags on cattle and other commercially produced animals. The surface of the animal is treated with a low-energy, non-sticking hydrophobic coating. The coating makes it difficult for polar substances, such as water, mud, dirt, waste, soil, manure and feed, collectively termed as dag, to adhere to the skin of the animal. The coatings are made from long-chain hydrocarbons, such as stearates, typically with a terminal metal carboxylate group of low-valence metals, e.g., mono or divalent metals, such as calcium, magnesium, potassium, sodium and zinc. The coatings are brushed onto the animals or are applied by bathing the animals in an aqueous solution of the coating.

One embodiment of the disclosure is a method for preventing dag formation on livestock. The method includes providing a metallic stearate salt in a form suitable for application to hair and skin of livestock and applying the metallic stearate salt to the hair and skin of livestock to form a self-assembled monolayer on the surface. The self-assembled monolayer provides a protective coating for livestock against at least one of mud, manure and feed.

Another embodiment of the disclosure is a coating for preventing dag formation on livestock. The coating includes a self-assembled monolayer formed on hair and skin of livestock, the self-assembled monolayer comprising a metallic stearate salt applied to the hair and skin of livestock.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 depicts one aspect of the problem, a steer with an acute accumulation of foreign matter clinging to the surface of the steer;

FIG. 2 depicts a metallic stearate composition according to the present disclosure;

FIG. 3 depicts an illustrative embodiment of a self-assembled monolayer of the metallic stearate composition applied to an animal according to the present disclosure;

FIG. 4 depicts a powered applicator of the metallic stearate composition according to the present disclosure;

FIG. 5 depicts an alternative embodiment of a composition for preventing dag formation using a monovalent metal according to the present disclosure;

FIG. 6 depicts an alternative method of applying a dag-prevention compound to livestock, according to the present disclosure;

FIG. 7 depicts an alternate coating that includes a mixture of metal stearates with both monovalent metals and divalent metals and long hydrocarbon chains; and

FIG. 8 depicts an alternate embodiment.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

In an embodiment, a method is disclosed for preventing the accumulation of foreign matter and dirt onto the surface of animals. The method includes: providing a metallic stearate salt in a form suitable for application to livestock and applying the metallic stearate salt to the livestock to form a self-assembled monolayer. The self-assembled monolayer provides a protective coating for livestock against at least one of mud, manure and feed.

As used in this disclosure, the term surface is meant the skin, hide, hair, wool or other covering of an animal. By the term dag is meant any foreign matter that clings to the surface of an animal. By the term low energy surface is meant a surface that repulses water and so has poor wettability. That is, the surface is hydrophobic or water-repellent (i.e., causes water to bead up). For this reason, such surfaces are difficult to wet and it is also difficult to adhere materials to these surfaces. One aspect of a low surface energy is the angle of contact of water to the surface. Low energy surfaces have a high water contact angle. An illustrative low energy surface has a contact angle from 95° to 115°.

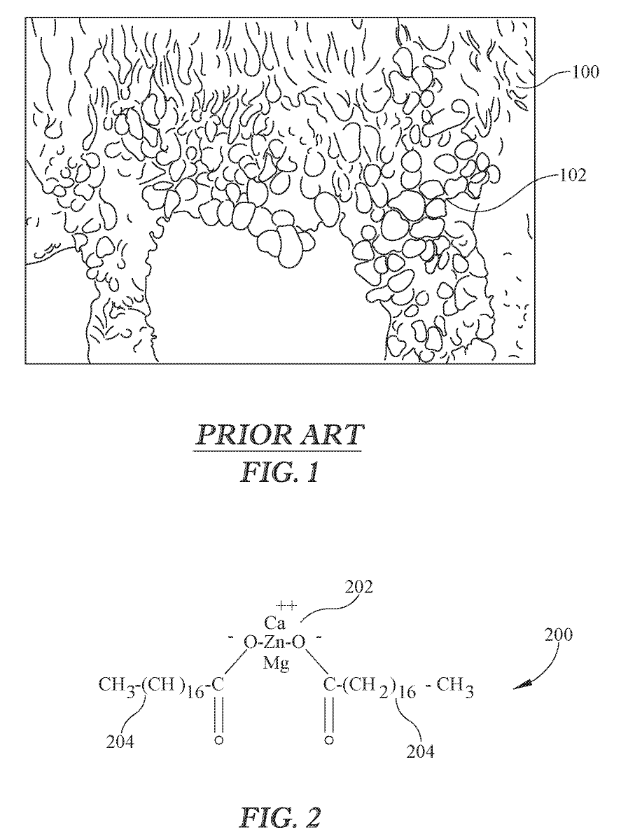

As noted, the problem of dag formation may be most acute in commercial livestock operations, such as a feedlot for cattle or other commercially-produced animals. These tend to be environments with large numbers of animals, in the presence of water or rain, producing animal waste, which can mix with mud, feed, soils and the like. As seen in FIG. 1, an animal 100 may accumulate dags 102 to a great extent. Cleaning the animal in FIG. 1 may require a great effort, which may be stressful for the animal and expensive for the owner, farmer, rancher or feedlot operator.

An illustrative example of an application for dag prevention of this disclosure is in the production of beef cattle. Beef production involves three stages of operation, which occur in different locations: the producer, a feedlot and the abattoir. Contamination is known to be not a significant issue in the producer, where the animals have room to graze and may not include unavoidable mud and areas in which manure may accumulate. Feedlots, on the other hand, may be crowded. Housing conditions during rainy periods may be especially conducive to dag formation. Since the next stage after feedlot is the abattoir, it makes sense for the feedlot operators to develop a methodology that can keep the cattle clean at all times. This may be in addition to “best” feedlot practices, such as designing the feedlot to reduce contamination, maintaining a clean facility, removing waste from under fences, periodically cleaning waste, minimizing contamination and allowing the cattle or other animals as clean an environment as possible. This may result in lower probabilities and incidence of dag formation on the animals.

Having thus introduced the foregoing overview on dag formation and how dags are highly undesirable, we now discuss the present disclosure, including illustrative embodiments of how animals may be treated to prevent dag formation.

In the present disclosure, live cattle or other animals are treated with a metallic stearate layer after they are tagged and admitted to the feedlot. They may also be cleaned prior to application of the coatings described herein. Metallic stearates are metal salts of stearic acid and are obtained via hydrolysis of naturally occurring fatty acid esters. The most common stearates are made with alkaline or alkaline earth metals, and a few other metals, such as zinc and aluminum. These tend to be low-cost chemicals that are used extensively in soaps, lubricants, mold-release agents, and fillers. They are used in applications ranging from personal care products, food additives, cosmetic additives, release agents and lubricants for machinery. They form a very versatile and useful array of products. They exhibit great film-forming properties and are hydrophobic with low friction when applied to surfaces.

Metallic stearates exhibit tremendous film-forming ability. When a soap-bar of metallic stearate is rubbed on a surface, a thin film, a self-assembled monolayer, is formed. In stearates, the monolayer includes a hydrocarbon chain of 18 carbon atoms, e.g., a stearate layer. This layer is hydrophobic, slippery with low friction and may protect the cattle from contamination by mud, manure and feed.

Examples of metallic stearates are depicted in FIG. 2. In particular, FIG. 2 shows calcium, zinc, and magnesium stearates.

A divalent metallic stearate 200 includes a divalent metal 202, such as calcium, magnesium or zinc, and two stearate C₁₈ chains 204. They are insoluble in water and hydrophobic. These compounds are white powders with melting points illustratively ranging from 120 to 160° C.

Stearic acid is illustratively synthesized by saponification of the triglycerides from vegetable oil and fat with water at 200° C. Other long carbon chain lengths may also be used, e.g., C₁₆, C₂₀ and C₂₂ chain lengths. In addition, the C₁₈ is a particularly effective chain length for forming a stable stearate film according to this disclosure. The C₁₈ chain length hence provides an illustrative preferred embodiment in the practice of this disclosure. Hydrocarbon chains of other lengths may also be used.

Without being limited to the theory, it is believed that the divalent metal is present as the ionic species, M⁺², e.g., Ca⁺², Zn⁺² or Mg⁺². The stearate chains 202 are believed to be present as monovalent anions, e.g., each of two chains comprising a C₁₈ stearate chain, CH₃—(CH₂)₁₆—COO⁻. In short, the stearates of the present disclosure include zinc, calcium, and magnesium salts of stearic acid. Other stearates and other molecules, as discussed below, may also be used.

Metallic stearates exhibit tremendous film-forming ability. When a soap-bar of metallic stearate is rubbed on a surface, a thin film, comprising a self-assembled monolayer of C₁₈ hydrocarbon chains is formed. This layer is hydrophobic and slippery and has low friction. This layer makes it difficult for soil, mud, manure, feed and other foreign substances to adhere to the surface of an animal. Dags are more difficult to form on the surface of an animal protected with a coating as described herein. The layer may thus protect the cattle from contamination by mud, manure and feed.

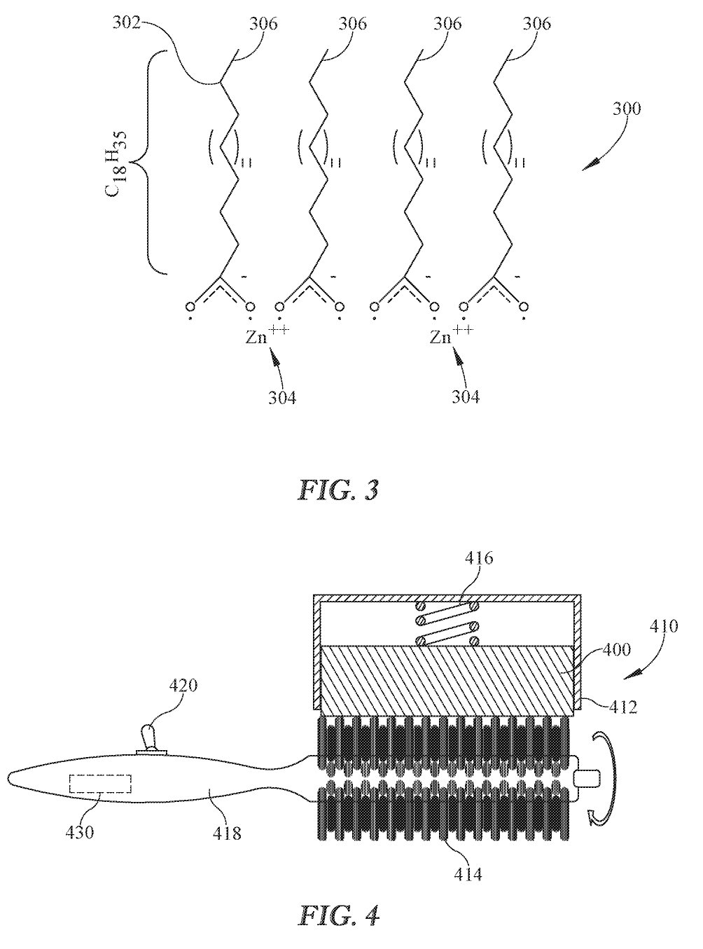

As depicted in FIG. 3, it is believed that the stearates may form a self-assembled monolayer 300 on the surface of the cattle or other animal. As FIG. 3 depicts, metallic stearates 302 include a divalent cation 304, in this case Zn⁺². Each stearate 302 will include the zinc ion 304 and will also include two stearate chains 306, each stearate chain illustratively including 18 carbon atoms and 35 hydrogen atoms, each chain terminating with a carboxylate group, COO⁻. The metal carboxylate groups will anchor onto the surface or skin of the cattle or other animal through polar-polar interactions. For example, the surface may include amino acids and protein. The metal carboxylate groups may interact with the amino acids and proteins present in the skin by virtue of the polar-polar interaction, whereby the hydrocarbon chains will interact to each other forming a self-assembled monolayer. The self-assembled monolayer, which is essentially hydrocarbon chains, imparts hydrophobicity and low friction, protecting the cattle from dag contamination.

The stearate chains spread out on the surface of the animal, as shown in FIG. 3, self-assembling into a layer with ordered hydrocarbon chains. In other words, the metal carboxylate groups may interact with the skin and the hydrocarbon chain may self-assemble at the same time, forming a self-assembled monolayer. Metal stearates are surfactant molecules and they comprise a C₁₈ hydrocarbon chain with a metal carboxylate polar group. When one applies a metal stearate on a polar surface, such as the skin of the cattle, the metal carboxylate group will interact with the polar sites, anchoring the molecules on the surfaces. The C₁₈ hydrocarbon chains will interact with each other, forming a self-assembled monolayer. For surfactants with shorter hydrocarbon chain, such as C₁₂, the surfactant will still anchor to the skin, but no self-assembled monolayer is formed, offering little protection. For surfactants with longer hydrocarbon chain, such as C₂₄ or longer, hydrophobic interaction will dominate, which will weaken both the self-assembling and the anchoring processes. Specifically, the surfactants may not organize as shown in FIG. 3.

Metallic stearates, as discussed above, may include zinc, calcium and magnesium salts of stearic acid. Metallic stearates formed with divalent salts are hydrophobic and relatively insoluble in water. They have been used as a mold releasing agent in the rubber industry, as non-sticking layers for uncured rubber and plastics, and as lubricants in machinery. Because of their hydrophobicity and film-forming property, metallic stearates applied to the surface of cattle or other animals form a hydrophobic, non-sticking coating on the surface of the cattle or other animal. The stearate layer protects the cattle from mud, manure and feed contamination. In general, stearates and their salts are edible and thus do not have to be removed before or after slaughtering. A small amount of stearate salt can remain on the surface of the animal when it is delivered to the meat processor or tannery.

The stearate compound can be applied to the animal in one or more of several possible methods. The simplest method may be to form the metallic stearate into a convenient form, such as a bar of stearate soap 400 in one illustrative example, as shown in FIG. 4. Zinc stearate is a soft, white powder and calcium stearate is a white waxy powder. Magnesium stearate is a white powder which becomes a solid at room temperature and below. Each of these can be combined with stearic acid, which is a waxy solid at room temperature. A bar of soap may also be formed with other additives, such as wax.

In one illustrative example, the owner or a helper can manually apply the stearate to the surface of the animal by rubbing the soap bar 400 on the surface of the animal. Another illustrative embodiment is to use the powered brush 410 that is also depicted in FIG. 4. In this example, the soap bar 400 is loaded into a housing 412 of the brush, the soap bar urged against bristles 414 of the brush by a spring 416 contained within housing 412. The brush 410 includes a handle 418 with an on/off switch 420 for controlling a power supply 430 that may be contained within the handle. The power supply 430 can be a battery within the handle. Other embodiments may be designed for use with electric power from a nearby convenience outlet.

This powered version allows a user to apply the compound to many animals in a convenient and controlled manner. When the electricity is on, the brush will rotate and the bristles and fibers in the brush will be uploaded with metallic stearate when the fibers are in contact with the soap bar. The concentration of the metallic stearate on the brush is a function of pressure, contact time, rotation speed, and the like. Once the brush is loaded with metallic stearate, it can then be manually or automatically brushed onto the cattle, spreading the stearate compound onto the animal so that a self-assembled monolayer is formed on the surface. Of course, this brushing process can be automated during a clean-tag-check-out line at the feedlot when cattle arrive at the feedlot from, for example, a producer of feeder cattle who sells to the feedlot. The coating may also be applied at any convenient time.

The metallic stearate layers are highly hydrophobic, with a water contact angle from 95 degrees to 115 degrees, indicating a high degree of hydrophobicity. This also means that the surface to which the compound is applied may repel water or other materials containing water, such as wet mud, wet manure and wet feed. The surface may resist attracting such materials and may at least have a high degree of resistance to dag formation.

While the coating is applied and is self-assembled onto the surface of the animal, a single layer may not be sufficient to inhibit all dag formation. Accordingly, the coating may be applied in two or more applications to ensure better coverage. A coating or subsequent coating is desirably applied while the animal is in a relatively clean state, so that the coatings are applied to the surface of the animal, rather than applied to dirt or already-formed dags—which may not be effective to protect the animal.

The low-energy, non-sticking coating is desirably made with divalent metallic stearates, such as the zinc, calcium and magnesium. As discussed, the long hydrocarbon chains may be stearate chains, C₁₈, that is, a generally linear hydrocarbon chain, as discussed above, terminating with a metal carboxylate group. Stearates are generally the least expensive and most available, most naturally occurring variety. The metallic stearates and other low-energy, non-sticking coatings disclosed here may be prepared by reactions of the carboxylic acid form of the long chain hydrocarbon and other chemicals. For example, zinc stearate is commonly produced by reacting sodium stearate with zinc sulfate. Similar routes may be used for other embodiments of the low-energy, non-sticking coatings discussed herein. In another example, calcium stearate may be produced by heating stearic acid with calcium oxide, producing calcium stearate and water. Magnesium stearate may be produced by heating sodium stearate with magnesium sulfate. Other routes may be used.

When the low-energy, non-sticking coatings according to the present disclosure are applied to an animal, the hydrocarbon chain may be any of a variety of lengths. The most common length, as discussed above, is a stearate C₁₈ chain in which the first carbon atom is part of a carboxylate group and the last carbon atom is a methyl group. Other lengths of the carbon chain may be used, illustratively ranging from C₁₆, the palmitate, to C₂₀, and may also include small amounts of other hydrocarbon chain lengths, e.g., C₂₂ and C₁₄. Other lengths may also be used. Commercial “stearic acid” may illustratively be a mixture of approximately equal amounts of stearic acid (C₁₈, octadecanoic acid) and palmitic acid (C₁₆, hexadecanoic acid) with a small amount of oleic acid.

There may also be small amounts of related unsaturated acids, such as oleic acid, cis-9-octadecenoic acid, an unsaturated C₁₈ cis-isomer. Also included may be small amounts of linoleic acid (cis,cis-9,12-octadecadienoic acid) and linolenic acid (cis,cis,cis-9,12-15-octadecatrienoic acid). While the straight-carbon-C₁₈-chain is the nominal structure, all structural isomers are intended. It is also understood that while the term “stearate” is used, the compounds intended include a plurality of lengths of the carbon chain, illustratively from C₁₆ to C₂₀, as discussed, or of other length, and may also include a variety of chemically similar structures with shorter or longer hydrocarbon chains. Accordingly, the term stearate, stearic acid, and related terms, as used in this patent document, is intended to mean all the long-chain fatty acid or hydrocarbon structures discussed, whether saturated or unsaturated. It is understood that commercial quantities of these compositions are mixtures of various chain lengths, degrees of saturation, straight chain and cis isomers, and so forth.

The largest source of stearates may be animal fats, such as beef tallow and lard. Stearates are also formed as part of vegetable oils. Vegetable oils typically include unsaturated varieties, such as the C₁₈ enoic acid, found in corn oils, cottonseed oils, olive, palm peanut and soybean oils. Hydrogenation will reduce the oil to the saturated state, e.g., the stearate, for use in stearate-type products.

In addition to divalent metals, it is also possible to form stearates or other compounds with monovalent metals, such as lithium, potassium and sodium. Thus, sodium stearate, potassium stearate and lithium stearate may also be used as a protective low-energy, non-sticking coating to prevent dag formation. Lithium stearate may have properties that may make it less desirable for use with livestock intended for food production, as well as being much more expensive. Sodium and potassium compounds have many of the advantages discussed above for the divalent compounds, without the disadvantages that may be associated with lithium.

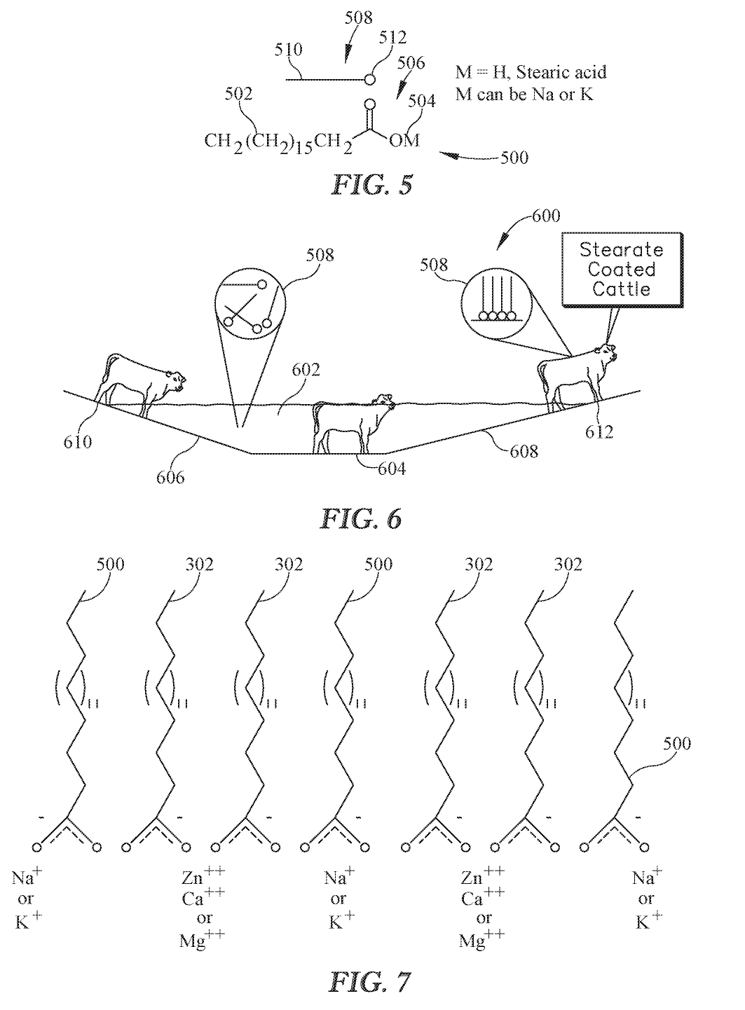

The structure of monovalent stearates or other long-chain hydrocarbon products is disclosed in FIG. 5. Coatings made from monovalent metals comprise a plurality of molecules 500 formed from a monovalent metal hydroxide and a fatty acid. As discussed above, one end of the stearate group 502 is a carboxylate group 506. As a surfactant, metal stearate consists of a non-polar hydrocarbon chain and a polar metal carboxylate group. The metal carboxylate portion of the molecule may thus tend to interact with polar sites on a surface of an animal, such as an amino acid or protein on the surface of the animal. Structure 508 is a simplified representation of a molecule 500 of the compound, depicting a hydrocarbon chain 510 and a polar metal carboxylate group 512.

In general, stearates of the divalent metals, such as calcium, magnesium and zinc, are insoluble in water and are applied to the animals, as noted above, as a solid, waxy compound from a bar of soap. The monovalent stearates also tend to be waxy solids at room temperature, but they are generally soluble in water. Thus, low-energy, non-sticking coatings made with monovalent stearates can also be applied by the soap-bar technique discussed above.

The monovalent stearates, however, can also be dissolved in water and used to form a solution or a bath used to protect cattle or other animals from dag formation. Thus, as depicted in FIG. 6, a bathing facility 600 may be prepared using a solution 602 of the sodium or potassium salt of stearate, depicted in FIG. 6 as a plurality of molecules 508. The facility may include a bath or trough 604 with an inclined entrance 606 and an inclined exit 608. The facility should be designed for ease of use with herds of cattle, e.g., for relatively fast processing of one or more animals at a time. The facility should be designed for operation by only one person, to keep the cattle moving through the bath and minimize time and cost required for coating.

In one illustrative embodiment, a weight percent of sodium and potassium stearate may be 0.5 to 10% with 2 to 7% preferred. A temperature range may be 15 to 35° C. with 20 to 30° C. preferred.

The dimension of the bath will depend on the size of the cattle. With a height of the cattle of about 1.4 m (meter), the dimension for the deepest section of the bath may be 1 m wide, 2-3 m long and 1.3 m tall. This may coat all parts of the body of the animal but for the back. A deeper bath may be configured to provide coating to the back if coating the back may be necessary. A ramp useable for the animals to walk into the bath should not stress the cattle. Illustratively, a down ramp having greater than a 30° inclination and an up ramp having a 20° inclination may be used. The dimensions of the bath and ramp inclination are a matter of design choice.

When the animals 610 are treated with the solution, the hydrocarbon chains self-assemble into a hydrophobic coating. The animals may be herded through the bath, emerging with a protective coating as treated animals 612. It should be understood that the compound, e.g., sodium stearate, may be present in the solution in an ionized form, sodium ions and stearic acid anions (stearate), while the compound that is self-assembled onto the cattle is present as the compound itself, ideally sodium stearate or other monovalent metallic stearate.

After bathing and drying, the stearate or other long-chain moiety is molecularly adsorbed onto the surface, forming monolayers self-assembled by the C₁₈ chains, or chains of other lengths. Without being bound by theory, it is believed that the driving force for the self-assembling process is the hydrophobic interaction among hydrocarbon chains and the metal carboxylate groups serve as anchors by interacting with the polar functional groups on the skin/hide/hair of the cattle.

It is also possible to prepare coatings using stearates of both monovalent and divalent metals. While the monovalent species, such as sodium stearate and potassium stearate are relatively soluble, the divalent species, such as calcium, zinc or magnesium stearates, are less soluble. As discussed below, these divalent cations are known to stabilize the self-assembled monolayers (coatings) and the adsorbing surface. When both species are deposited on the animal, the coating may appear as shown in FIG. 7, as an ordered, self-assembled mixture of divalent stearates 302 and monovalent stearates 500. The divalent cations may be introduced into solutions of the monovalent species by adding amounts of soluble species, e.g., calcium hydroxide or magnesium hydroxide. These species may tend to raise the pH of the solution, which must be controlled for proper deposition and adsorption onto the desired surfaces. Zinc hydroxide may be used, but is less soluble. Alternatively, the divalent cations may also be introduced as chlorides.

In view of this disclosure, it will be seen that technologies are generally described for applying non-sticking coatings to the surface of animals. While particular substances have been identified and described in this disclosure, there are many other additional substances that may also be used. For example, trivalent metals such as aluminum also form salts with long-chain carboxylic acids and may be used. Stearates may be formed with monovalent alkali metals, such as sodium and potassium, and stearates may also be formed with the alkaline earth metals, such as magnesium and calcium. Transition metals, such as zinc, are also useful in forming stearates or other long-hydrocarbon-chain carboxylic acid salts, as are what may be considered “post-transition” metals, e.g., aluminum and tin. These tend to be more expensive than the alkali and alkaline-earth species.

The application of the low-energy, non-sticking coatings of the present disclosure modifies the surface property of the surface, such as hair hide or both or other surface of animals that are so treated. The surfaces of the animals that are so treated have a low surface energy, that is, the surfaces tend to be hydrophobic or water-repellent. For this reason, such surfaces are difficult to wet and it is also difficult to adhere materials to these surfaces. One aspect of this low surface energy is the high water contact angle that results from such treatment. The water contact angle in some applications may be from 95° to 115°.

As noted above, the coating may be brushed onto the animals, especially with coatings made with a divalent metal, such as zinc, calcium and magnesium. The animals may also be treated with coatings made with a monovalent metal, such as sodium or potassium, by bathing the cattle or other animal, or by spraying the animals with a coating made according to this disclosure. Spraying works well, but has a disadvantage of wasting the coating, the waste adding no value and having a disadvantage that it must be cleaned up. After drying, a self-assembled monolayer comprising the C₁₈ chains, and possible amounts of other shorter or longer chains, is molecularly adsorbed onto the surface of the cattle, swine or other animals that have been treated.

The surfaces of the monolayers formed from stearic acid and other long-chain carboxylic acids are known to be slippery, with a low sliding angle. It has been reported that a single layer of stearate can drastically reduce the friction of a glass substrate. The sliding angle for water on a glass slide is typically greater than 60 degrees, decreasing to about 6 degrees after the surface of the glass is coated with a monolayer of stearic acid by the Langmuir-Blodgett (LB) film technique. The water contact angle for a single LB layer of C₁₈ hydrocarbon chain was found to be between ninety (90) and one hundred ten (110) degrees, depending on the terminal polar group. The result also depended on the substrate and the film deposition conditions. Examples of terminal polar groups included amine (—NH₂), carboxyl (—COOH) and metal-terminated carboxyl (—COOM), where M is a metal ion.

It has also been reported that a well-packed LB layer of octadecylamine produced an advancing and receding water contact angle of 113 degrees or 62 degrees, respectively, comparable to a vacuum deposited thin film. The water contact angle for the LB layer is usually inferior due to interaction between water molecules and carboxyl group during contact angle measurement, which overturns the adsorbed molecules. On the other hand, the stability of the adsorbed monolayers can be improved by including divalent cations, such as Ca⁺² into the solution. Divalent cations are known to enhance the interaction between the adsorbing surface and the carboxylate group, thus enhancing the packing of the hydrocarbon chains and improving film stability.

With metallic stearate solutions of this disclosure as explained in connection with FIG. 6, other conditions that can increase hydrophobicity and repellency of the adsorbed stearate or other long chain hydrocarbon film include the use of a high stearate concentration and a stearate solution with a pH below 10. Aqueous solutions of monovalent (alkali metal) stearates are basic. The equilibrium reaction between water and sodium stearate in solution is given here in Eq. 1:

C₁₇H₃₅COONa+H₂O<-C₁₇H₃₅COOH+NaOH

Equilibrium in this reaction favors the left side, with a small amount of stearic acid and sodium hydroxide, as shown on the right side. Stearic acid, on the right side, is much less soluble than sodium stearate, on the left side. Accordingly, stearic acid may preferably be adsorbed and coated onto the surface of the animal during bathing, for example. The continuous removal of the stearic acid may tend to increase the basicity of the stearate solution, thus increasing the pH of the solution. The solution may eventually degrade or inhibit the stearate coating process. To counter this, one needs to control the pH of the stearate solution, illustratively with a buffer solution. One possible buffer is tris(hydroxymethyl)aminomethane (“Tris”), which has an effective range for a pH between 7.5 and 9.0. A good pH is below 10, e.g., between 8 and 9.5.

If a small amount of dag is formed on the stearate-treated cattle and removal of the dag is desired, the stearate coating can be removed by bathing the contaminated cattle in a second bath comprising a dilute solution of base, e.g., with a pH up to about 10.5. In basic solution, the adsorbed stearate may convert to water-soluble sodium stearate and the adsorbed coating (stearate film) may come off the cattle. When the contaminated coating comes off, the dag may also be removed. The cattle or other animals can then be re-processed with a clean bath and a clean non-stick coating.

As explained above, the adsorption is caused by the attractions and the specific interactions between the metal carboxylate group and polar functional groups on the cattle or other animals. Without being bound by any particular theory, these groups may include amino acids and proteins that form a part of the surface of the animals. The long-chain hydrocarbon portion of the molecule is hydrophobic, slippery with low friction and possibly exhibiting superhydrophobicity in certain situations. Superhydrophobicity is a property of a nanoscopic surface that repels water. It is possible that at least portions of the surface of the animal may be clean and dry, and an adsorbed coating according to the present disclosure may exhibit superhydrophobicity. The hydrophobic properties of the coatings of this disclosure may protect the cattle from contamination by dags during their stay in feedlots. These properties may also protect cattle and other animals from dags in other situations, such as muddy pastures or other situations in which the animals are susceptible to mud, dirt, manure, waste, and so on.

There are many embodiments of the present disclosure. It is clear from the above that metallic salts of long chain hydrocarbons, such as long chain carboxylic acids, may be used to form low-energy, non-sticking coatings that are effective to prevent dag formation on animals during pasture and feedlot settings. These salts, such as metal salts of stearic acid, have been used as a mold release agents in industry. They have been used as a mold release agent in molds used for rubber and plastic production. Examples include injection molding and thermoforming processes. These coatings have been used as a non-sticking layer for uncured rubber or plastic. They are also widely used as lubricants in machinery. They have long been used as soaps and they are now used in foods and cosmetics.

The following table provides illustrative examples of the metal stearates that may be used with this disclosure. The table also provides the molecular weight, melting point, solubility in water, and how it was made.

| | | | | Solubility | |
|---|---|---|---|---|---|
| | | | m.p. | in water | How it was |
| Chemical | Formula | M.W. | (° C.) | (25° C.) | made |
| Lithium | C₁₇H₃₅CO₂Li | 290 | 220.5-221.5 | 0.01 g in | Stearic acid + |
| stearate | | | | 100 g water | LiOH |
| Sodium | C₁₇H₃₅CO₂Na | 306 | 245-255 | Soluble | Stearic acid + |
| stearate | | | | | NaOH |
| Potassium | C₁₇H₃₅CO₂K | 322 | 240 | Soluble | Stearic acid + |
| stearate | | | | | KOH |
| Zinc stearate | (C₁₇H₃₅CO₂)₂Zn | 632 | 130 | Insoluble | Stearic acid + |
| | | | | | ZnO |
| Calcium | (C₁₇H₃₅CO₂)₂Ca | 606 | 155 | 0.004 g in | Stearic acid + |
| stearate | | | | 100 g water | Ca(OH)₂ |
| Magnesium | (C₁₇H₃₅CO₂)₂Mg | 590 | 200 | 0.004 g in | Stearic acid + |
| stearate | | | | 100 g water | Mg(OH)₂ |
| Aluminum | (C₁₇H₃₅CO₂)₃Al | 876 | 103 | Insoluble | Sodium stearate + |
| stearate | | | | | Al₂(SO₄)₃ in |
| | | | | | water |
| Aluminum | (C₁₇H₃₅CO₂)₂Al | 610 | — | Insoluble | Sodium stearate + |
| distearate | OH | | | | Al₂(SO₄)₃ in |
| | | | | | water (less Al |
| | | | | | salt) |
| Aluminum | (C₁₇H₃₅CO₂)Al | 344 | — | Insoluble | Sodium stearate + |
| monostearate | (OH)₂ | | | | Al₂(SO₄)₃ in |
| | | | | | water (less Al |
| | | | | | salt) |

The selection of a particular metallic stearate to use may depend upon the particular application and is a matter of design choice. For example, from the table below, it may be seen that all metal stearates may be made into soap bars and applied to the surface of the cattle using the brush technique as previously explained. The particular metallic stearate of choice may depend upon, for example, the available resources for making the bar of soap and may also depend upon the hydrophobic effect desired for a particular animal. Sodium and potassium stearates may be used in the water bath technique as they are soluble in water as also previously explained.

The soap bar may illustratively be prepared by molding technique, particularly under heat and pressure (compression molding). In one embodiment, the mold is first filled with metal stearate powder. Heat is then applied (temperature below the melting point or decomposition point) to the mold to soften up the powder. This is followed by applying pressure to press the powder into a “hot cake,” forming a stearate soap bar upon cooling. Alternatively, metal stearate can be heated to a molten state and the liquid is poured into a mold. A soap bar is formed when the molten stearate cools and solidifies. The latter only applies to stearates that are stable without decomposition at melting. Of course, if one uses a mixture of powder of stearates, a soap bar of mixed stearate can be obtained.

When a surfactant such as sodium or potassium stearate dissolves in water at low concentration, the molecules may distribute randomly in the solution that is formed. Above the so-called critical-micelle-concentration (CMC), the molecules may form micelles and at a concentration above that, may form a gel. A stearate film may form after a surface coated with the solution is dried. Since the skin and hair of the cattle or other animals comprise polar groups, the metal carboxylate group may attach to the surface of the skin or hair and the hydrocarbon chains may interact to each other in a two-dimensional form creating a hydrocarbon coating on the surface of the skin. This is the so-called hydrophobic interaction, which is the driving force for the formation of the stearate film.

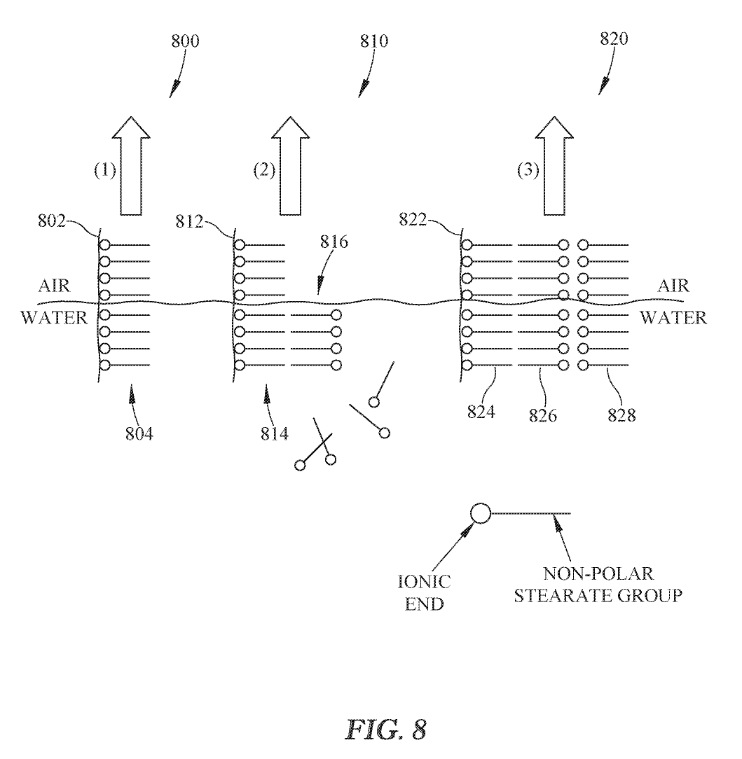

As shown in the left portion 800 of FIG. 8, a monolayer of stearate film 804 may be formed and may coat the cattle skin or surface 802 when the concentration of the stearate is sufficiently high, such as above the CMC of the surfactant. Each molecule of the stearate is represented by a straight portion with a circle on the end. The straight portion represents the non-polar hydrocarbon chain and the circle represents the polar portion, e.g., the metal carboxylate group. The CMC of sodium stearate is estimated to be ˜0.28 wt %.

The animal and the coated monolayer leave the water after application of the solution, represented by the large arrow in each of the three situations. In the left portion of FIG. 8, the upper portion of cattle skin or surface 802, as the animal leaves the bath or application area, the coating may remain on the skin or the surface 802 due to the strong dipolar interaction between the skin and the polar portion of the coating molecule. This is also aided by the repellent force between water and the non-polar C₁₈ hydrocarbon chain.

The central portion 810 of FIG. 8 illustrates the situation when sufficient stearate is available to form two layers 814, 816 during coating. The first layer 814 forms and attaches to the skin or surface 812, as in the first example described above. The second layer 816 may also form but may be unstable when the animal and the coated surface leaves water, shown by the large arrow in the central portion of FIG. 8. Specifically, as the animal leaves the bath, the second layer 816 may be washed away by water because the ionic portions of the coating molecules in the second layer are heavily solvated by water molecules. This is shown in the upper portion of coating 816, as molecules of the coating are washed off, perhaps re-entering the solution, or later washed off by rain.

In some instances, as shown in the right portion 820 of FIG. 8, three layers, 824, 826, 828 are able to coat the surface 822. The three layers may remain on the skin or surface because water may be unable to wash away the outer hydrocarbon layer 828. It is important to note that FIG. 8 represents an ideal case for the organization of the C₁₈ hydrocarbon chains. This ideal case can be obtained in the lab under Langmuir-Blodgett film transfer conditions. In reality, the C₁₈ hydrocarbon chains in the stearate film may be less organized.

For the dry brush method, stearate films will form, but the hydrocarbon chains may not be as organized compared to those formed from the bath technique. An advantage of this approach is that one can apply the equivalence of multiple layers of materials easily.

These coatings have excellent hydrophobic properties, slippery as well as excellent film-forming properties. The coatings may be formed from long chain carboxylic acids and a variety of metals, including monovalent sodium and potassium and divalent metals, including zinc, calcium and magnesium, as discussed above. In general, these compounds are presently used in foods for human consumption or are generally recognized as safe. Hydrophobic coating with other metals may also be possible, such as lithium or aluminum, but their consumption by people should be limited, and hence their use should be minimized in these applications.

By limiting the make-up of the components of the coating, it may not be necessary to wash or cleanse the cattle, or other animals, when they are processed for food applications, e.g., at the slaughter house. It is also believed that the coatings will not adversely affect the surface of cattle or other animals during processing at a tannery, e.g., for leather production. The coating can remain on the surface when the animal is delivered for processing or tanning.

There are many advantages to the disclosed methods, including more sanitary conditions for cattle or other animals treated by the solutions and methods disclosed above. The self-assembled monolayers of stearate and other long-chain hydrocarbons coat the surface of cattle, sheep and other animals and prevent dag formation, primarily during rainy periods, such as the rainy season in certain countries and climates. The self-assembled monolayers may be formed by bathing cattle in a stearate bath, such as an alkali stearate bath, e.g., sodium or potassium stearate. In another method, the self-assembled monolayers may be formed by brushing or coating the animals with bristles from a brush, the bristles applying a solid coating, such as the long-chain hydrocarbon coatings discussed herein.

Coatings are more easily applied using an alkali solution, since the cattle or other animals need merely to be herded through the bath to apply the coating. As discussed above, the pH of the alkali solution can be controlled by a buffer that maintains the pH below 10, e.g., between 8 and 9.5, or other acceptable and effective range, throughout the coating process. While salts of (monovalent) alkali metals are effective, the quality of the coatings can be improved by salts of divalent metals as well, such as Ca⁺², Zn⁺² or Mg⁺². The divalent salts have been shown to be a key enabler for an increase in the repellency of stearate-treated soil samples. There are many potential advantages in the disclosed methods and compositions. The benefits in using the disclosed methods allow for clean, dag-free cattle in the feedlot prior to slaughtering. The cattle may have less stress because they do not have to contend with quantities of dags. The owners and processors can keep the cattle that way, and lower their own stress levels, by avoiding a need to clean cattle to free them from dags. Cattle processed with the disclosed methods may be much cleaner than at present, freeing buyers and sellers from considerations of dirt and contamination of the processed meat and hides and other surfaces of the animal.

As disclosed herein, there are several methods for applying the coatings. The low-energy, non-stick coatings disclosed herein can be applied individually to small herds or show animals by manual brush application or by a powered brush application. Larger quantities or herds may be processed by walking or herding the animals through a bath or a tank with a solution of the coating, as shown and discussed above.

There is thus disclosed a method for preventing dag formation on livestock. The method includes steps of providing a metallic stearate salt in a form suitable for application to hair and skin of livestock and applying the metallic stearate salt to the hair and skin of livestock to form a self-assembled monolayer on the surface, the self-assembled monolayer providing a protective coating for livestock against at least one of mud, manure and feed.

In another embodiment, the metallic stearate salt comprises a stearate and an alkali metal. In yet another embodiment, the metallic stearate salt comprises a stearate and an alkaline earth metal. In another method, the metallic stearate salt comprises a stearate and a transition metal. In another method, the metallic stearate salt is selected from the group consisting of calcium stearate, zinc stearate and magnesium stearate. In yet another method, the metallic stearate salt is selected from the group consisting of sodium stearate, potassium stearate, and lithium stearate.

In another method, the step of applying includes applying the metallic stearate salt as a bar of soap. In another method, the bar of soap comprises a mixture of the metallic stearate and a wax. In another method, the step of applying comprises applying the metallic stearate by a stearate soap brush applicator. In one method using the brush, the step of applying comprises rotating the brush against the soap bar to collect metallic stearate salt onto the brush and further rotating the brush against the hair and skin of livestock to deposit the collected metallic stearate salt onto the hair and skin of livestock. In another embodiment, the method further comprises applying the metallic stearate salt to the hair and skin of livestock by a bath of water comprising the metallic stearate salt. One method further comprises applying the metallic stearate in an automated manner. In embodiments, the automated manner may be selected from the group consisting of automated spray application, automated brush application, and automated bath application. In embodiments, the metallic stearate salt comprises a metal carboxylate group, and a hydrocarbon chain; and the step of applying the metallic stearate salt enables the metal carboxylate group to interact with the hair and skin of the livestock to bind the self-assembling monolayer to the hair and skin of the livestock, and also enables the hydrophobicity of the hydrocarbon chain to prevent the dag formation.

In another embodiment of the disclosure is a coating for preventing dag formation on livestock. The coating includes a self-assembled monolayer formed on hair and skin of livestock, the self-assembled monolayer comprising a metallic stearate salt applied to the hair and skin of livestock.

In one embodiment, the metallic stearate salt comprises a stearate and an alkali metal. In another embodiment, the metallic stearate salt comprises a stearate and an alkaline earth metal. In another embodiment, the metallic stearate salt comprises a stearate and a transition metal. In yet another embodiment, the metallic stearate salt is selected from the group consisting of calcium stearate, zinc stearate and magnesium stearate. In one embodiment, the metallic stearate salt is selected from the group consisting of sodium stearate, potassium stearate, and lithium stearate.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method for preventing dag formation on livestock, the method comprising:
providing a metallic stearate salt in a form suitable for application to livestock; and
applying the metallic stearate salt to the livestock to form a self-assembled monolayer, the self-assembled monolayer providing a protective coating against at least one of mud, manure and feed.

2. The method of claim 1, wherein the metallic stearate salt comprises a stearate and an alkali metal.

3. The method of claim 1, wherein the metallic stearate salt comprises a stearate and an alkaline earth metal.

4. The method of claim 1, wherein the metallic stearate salt comprises a stearate and a transition metal.

5. The method of claim 1, wherein the metallic stearate salt is selected from the group consisting of calcium stearate, zinc stearate and magnesium stearate.

6. The method of claim 1, wherein the metallic stearate salt is selected from the group consisting of sodium stearate, potassium stearate, and lithium stearate.

7. The method of claim 1, further comprising applying the metallic stearate salt as a bar of soap.

8. The method of claim 7, wherein the bar of soap comprises a mixture of the metallic stearate and a wax.

9. The method of claim 7, further comprising applying the metallic stearate by a stearate soap brush applicator.

10. The method of claim 9, wherein the step of applying comprises rotating a brush against the soap bar to collect metallic stearate salt onto the brush and further rotating the brush against the livestock to deposit the collected metallic stearate salt onto the livestock.

11. The method of claim 1, further comprising applying the metallic stearate salt to the livestock by giving a bath with water comprising the metallic stearate salt.

12. The method of claim 1, further comprising applying the metallic stearate in an automated manner.

13. The method of claim 12, wherein the automated manner is selected from the group consisting of automated spray application, automated brush application, and automated bath application.

14. The method of claim 1, wherein the metallic stearate salt comprises a metal ion, a carboxylate group, and a hydrocarbon chain; and
applying the metallic stearate salt enables the metal carboxylate group to interact with the livestock and the hydrocarbon chain to self-assemble to form the self-assembling monolayer on the livestock.

15. The method of claim 1, wherein the self-assembled hydrocarbon chain imparts hydrophobicity.

16. A coating for preventing dag formation on livestock, comprising:
a self-assembled monolayer formed on livestock, the self-assembled monolayer comprising a metallic stearate salt applied to the livestock.

17. The coating of claim 16, wherein the metallic stearate salt comprises a stearate and an alkali metal.

18. The coating of claim 16, wherein the metallic stearate salt comprises a stearate and an alkaline earth metal.

19. The coating of claim 16, wherein the metallic stearate salt comprises a stearate and a transition metal.

20. The coating of claim 16, wherein the metallic stearate salt is selected from the group consisting of calcium stearate, zinc stearate and magnesium stearate.

21. The coating of claim 16, wherein the metallic stearate salt is selected from the group consisting of sodium stearate, potassium stearate, and lithium stearate.
